(19) United States
(12) Patent Application Publication
(10) Pub. No.: US 2019/0122122 A1
(43) Pub. Date: Apr. 25, 2019

(54) PREDICTIVE ENGINE FOR MULTISTAGE PATTERN DISCOVERY AND VISUAL ANALYTICS RECOMMENDATIONS

(71) Applicant: TIBCO Software Inc., Palo Alto, CA (US)

(72) Inventors: Daniel J. ROPE, Reston, VA (US); Andrew J. BERRIDGE, Deal (GB); Michael O'CONNELL, Durham, NC (US); Gaia Valeria PAOLINI, Canterbury (GB); DivyaJyoti Pitamberlal RAJDEV, Mountain View, CA (US)

(21) Appl. No.: 16/168,661

(22) Filed: Oct. 23, 2018

Related U.S. Application Data
(60) Provisional application No. 62/576,187, filed on Oct. 24, 2017.

(51) Int. Cl. G06N 5/00; G06N 7/00; G06F 17/30

(52) U.S. Cl. CPC G06N 5/003; G06N 7/00; G06F 17/30958; G06F 17/30991; G06F 17/30997

(57) ABSTRACT

A predictive engine for interpreting data structures that includes an interpreter and visualization generator. The interpreter identifies a relational pattern between target feature variables and other feature variables based on recognizing a variable dependency between the target feature data and the other feature data and generate at least one meta-data feature set and associated result metrics. The visualization generator can recommend at least one visualization based on the at least one meta-data feature set and the associated result metrics. The interpreter includes multiple stages that perform variable selection, interaction detection, and pattern discovery and ranking. The predictive engine also includes a data preparer configured to sort, categorize, and filter the data structures according to at least one of data type, hierarchical data structures, unique values, missing values and date/time data.

### CROSS REFERENCE TO RELATED APPLICATION

This application claims priority to U.S. Provisional Patent Application No. 62/576,187, filed Oct. 24, 2017, entitled “Multistage Pattern Discovery for Visual Analytics Recommendations,” the entire contents of which are hereby fully incorporated herein by reference for all purposes.

### TECHNICAL FIELD OF THE DISCLOSURE

The present disclosure relates, in general, to artificial intelligence algorithms and predictive engines and, in particular, to a predictive engine for multistage pattern discovery and visual analytics recommendations.

### BACKGROUND

Predictive and visualization analytics are tools used in many domains. Governments, institutions, and businesses use these tools to manage and interpret big data. The tools can be of great benefit by interpreting large amounts of data and providing information about the data that can be used to aid users in making governance and management decisions. However, there are many drawbacks in the current state of the art of these tools. For example, they don't scale, they are domain specific, or they provide little or no insight. As such, there is a need for an improvement to current state of the art predictive and visualization analytics tools.

### SUMMARY

The present disclosure disclosed herein comprises a computing device having a mechanism configured to prepare data from a data structure, identify relational patterns between target feature variables and other feature variables, and recommend visualizations based on relational patterns.

In one aspect, the present disclosure is directed to a predictive engine for interpreting data structures that includes an interpreter and a visualization generator. The interpreter is configured to identify a relational pattern between target feature variables and other feature variables based on recognizing a variable dependency between the target feature data and the other feature data and generate at least one meta-data feature set and associated result metrics. The visualization generator is configured to recommend at least one visualization based on the at least one meta-data feature set and the associated result metrics.

In some embodiments, the interpreter includes multiple stages for performing variable selection, interaction detection, and pattern discovery and ranking. The variable dependency is one of a linear, non-linear relationship, and non-random pattern. In some embodiments, the predictive engine includes a data preparer configured to sort, categorize, and filter the data structures according to at least one of data type, hierarchical data structures, unique values, missing values, and date/time data. In some embodiments, the interpreter is further configured to perform a statistical test to determine whether an interaction effect is significant. In some embodiments, the visualization generator generates at least one or more of a multivariate chart and bivariate chart. In some embodiments, the visualization generator is further configured to apply heuristic based rules to recommend the at least one visualization.

In another aspect, the present disclosure is directed to a method for operating a predictive engine to interpret data structures. The method includes identifying a relational pattern between target feature data and other feature data based on recognizing a variable dependency between the target feature data and the other feature data; generating at least one meta-data feature set and associated result metrics; and recommending at least one visualization based on the at least one meta-data feature set and the associated result metrics.

The method can also include performing at a first, second, and third stage wherein variable selection, interaction detection, and pattern discovery and ranking at the step of identifying and generating. The variable dependency is one of a linear, non-linear relationship, and non-random pattern. The method can also include sorting, categorizing, and filtering the data structures according to at least one of data type, hierarchical data structures, unique values, missing values and date/time data. The method can also include performing a statistical test to determine whether an interaction effect is significant. The method further comprises generating at least one or more of a multivariate chart and a bivariate chart.

In a further aspect, the present disclosure is directed to non-transitory computer readable storage medium comprising a set of computer instructions executable by a processor operating a predictive engine to interpret data structures. The computer instructions are configured to identify a relational pattern between target feature data and other feature data based on recognizing a variable dependency between the target feature data and the other feature data; generate at least one meta-data feature set and associated result metrics; and recommend at least one visualization based on the at least one meta-data feature set and the associated result metrics.

Additional computer instructions can be configured to identify and generate the relational pattern and at least one meta-data feature set and associated result metrics at multiple stages wherein variable selection, interaction detection, and pattern discovery and ranking are performed; and/or sort, categorize, and filter the data structures according to at least one of data type, hierarchical data structures, unique values, missing values and date/time data; and/or generate at least one or more of a multivariate chart and a bivariate chart; and/or apply heuristic based rules to recommend the at least one visualization. The variable dependency is one of a linear, non-linear relationship, and non-random pattern.

Additional embodiments, advantages, and novel features are set forth in the detailed description.

### BRIEF DESCRIPTION OF THE DRAWINGS

For a more complete understanding of the features and advantages of the present disclosure, reference is now made to the detailed description along with the accompanying figures in which corresponding numerals in the different figures refer to corresponding parts and in which:

FIG. 1 is an illustration of a flow diagram outlining data interpretation and visualization functions associated with a multiple stage, machine learning, predictive engine algorithm, in accordance with certain example embodiments;

FIG. 2 is an illustration of a multiple stage, machine learning, predictive engine algorithm, in accordance with certain example embodiments;

FIG. 3-7, 8A-8B, and 9A-9B are illustrations of visualizations generated by the predictive engine; and

FIG. 10 is a block diagram depicting a computing machine and system applications, in accordance to certain example embodiments.

### DETAILED DESCRIPTION

While the making and using of various embodiments of the present disclosure are discussed in detail below, it should be appreciated that the present disclosure provides many applicable inventive concepts, which can be embodied in a wide variety of specific contexts. The specific embodiments discussed herein are merely illustrative and do not delimit the scope of the present disclosure. In the interest of clarity, not all features of an actual implementation may be described in the present disclosure. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would be a routine undertaking for those of ordinary skill in the art having the benefit of this disclosure.

Data visualization recommendation systems can be created in different ways. For example, pre-built visualizations enable lay-users to quickly gain a picture of their data, but are incapable of discovering and displaying algorithmic relationships between data fields. Another way is statistical analysis. Statistical analysis and visualizations can depict specific mathematical relationships and display them in ways that are meaningful to data scientists but are not designed to offer general insight to business users. In other words, these tools lack the general capabilities to present a business user with visualizations that are flexible enough to cover any business domain, and informed enough to depict interesting features and relationships from the start. Without such, valuable insight to one's business operations can be lost. Another way is pre-defined analytic routines. The results of which are displayed in specific visualizations (or narrations). These are only effective when domain specific. In addition, state of the art visualization recommendation systems typically use only the variable metadata. They do not examine relationships within the data.

In various embodiments, relationships within the data are examined by a predictive engine algorithm as disclosed herein. In various embodiments, multiple stages of machine learning are used to determine useful variable sets and metrics that can influence a heuristic visualization system. In various embodiments, results of machine learning algorithms are used to provide hints for visualization adornment to denote patterns within the visualization. The multi-stage approach is used to discover patterns for use in visualization recommendations. Multiple stage machine learning and heuristically-selected pre-built visualizations can be combined in an approach to deliver analytical insights to business users as standard business charts. Machine learning algorithms disclosed herein discover patterns within selected variables that can influence the variable role choices made by a heuristic visualization recommendation system. Machine learning algorithms also suggest visualization adornments that can help illustrate particular patterns or outlying values for a user.

The term target variable used herein means a particular attribute, also called feature, of interest in a data table, the variation of which can be described by other variables in the data. Data associated with this target variable are compared to data in other variables within records of the data table.

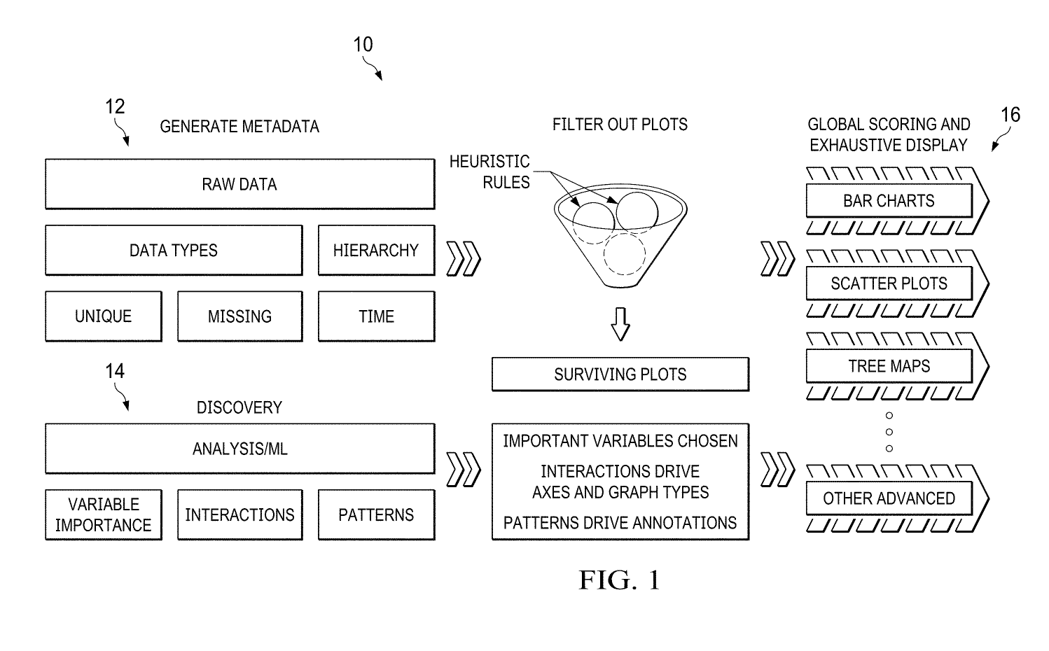

Referring now to FIG. 1, illustrated is a flow diagram outlining data interpretation and visualization functions associated with a multiple stage, machine learning, predictive engine algorithm, in accordance with certain example embodiments, denoted generally as 10. The flow diagram 10 identifies features associated with a multiple stage predictive engine with heuristic visualization recommender augmented with machine learning. The flow diagram 10 includes sections: data preparation 12; discovery 14; and heuristic visualization recommendation 16.

Data preparation 12 describes data preparation features where data is pre-processed to make adjustments that improve the quality of the data and, therefore, the predictive capabilities of the algorithm. In essence, the data is prepared by sorting, categorizing, and filtering the data structures according to at least one of data type, hierarchical data structures, unique values, missing values and date/time data. The raw data can be identified by data types (e.g. date or time) and hierarchy (e.g. year, month, hour, minute, etc. . . . ) and further identified as having at least one of the characteristics of unique, missing, and time. Adjustments can be applied to variables with missing data (for example: removal or imputation), to categorical variables exceeding a threshold of distinct values (for example: removal or marked for regrouping), and variables with only one value can be ignored. The rationale is to exclude variables that do not contain enough information or categories that are more likely to be labels rather than predictors of the target. If a user selects a target that was excluded for one of the reasons above, no insight will be generated, i.e. the user will see a standard histogram or bar-chart of the target variable.

Variables of date/time data type can be turned into the most-likely top element(s) of their own date hierarchy (e.g. year, month . . . ). In various embodiments, multiple levels of the hierarchy can be generated. The original date variable can be discarded. The top hierarchy element(s) become the date variable. Numeric variables can be binned using multiple techniques and the results can be aggregated, which increases the robustness of the results. These can be referred to as variable transformations. In addition, the algorithm can automatically transform variables to normalize, bin, or apply other calculations based on statistical metadata, i.e. determine min/max, moments, percent, frequency counts, etc. Categorical variables with too many levels can have an artificially large effect on the feature importance. As such, they can be regrouped to reduce the number of levels. Various methods can be used to determine the regrouping, including using specific thresholds or examinations of the frequency distribution. Unique values of a categorical variable can be counted. This helps determine how a variable is treated in the data preparation step. A new variable containing random data can be inserted into a data table during data preparation, for baselining signal vs. noise. This technique provides a mechanism to determine a significance threshold of relationships for analytic routines that may not supply an explicit test.

Once the data is prepared, data discovery 14 for the selected target is performed by the predictive engine algorithm. This can use machine learning algorithms, such as Random Forest, Gradient Boosted Trees, or statistical methods, such as Pearson Correlation, Cramer's V, ANOVA. Relationships between the target and other variables are calculated and ranked. Non-significant relationships are not used. Variable ranking can take into account findings beyond the relationships such as the number and relevance of particular annotations. The variable ranking is a single measure of ranking across 2-variable and 3-variable relations. The variable relationship algorithm can determine relationships between any sets of columns. The generated variable ranking is provided as input to 16.

The information generated by 14 can then be applied to best practice visualizations via heuristic rules that choose a good visualization. Several candidate visualizations can be generated and poor choices can be filtered out based on the rules provided in 14 combined with visualization heuristics. These combine into a global scoring or ranking. These rules are used to determine visualization types, axes and annotations. The global scoring, i.e. ranking, can be applied to the generated graphs and an exhaustive list of visualizations can be displayed.

A strength of the predictive engine algorithm is that it does not matter whether the relationship is linear, non-linear, clustered, etc . . . It is capable of spotting any interesting relationships where the values in the predictor columns drive the values in the target column in some non-random way. The use of stages in the predictive process differentiates the results of the predictive engine algorithm because it allows for the discovery of relationships, interactions, and patterns in a combined manner. The predictive engine algorithm is capable of discovering linear/non-linear relationships as well as depicting the patterns and outliers.

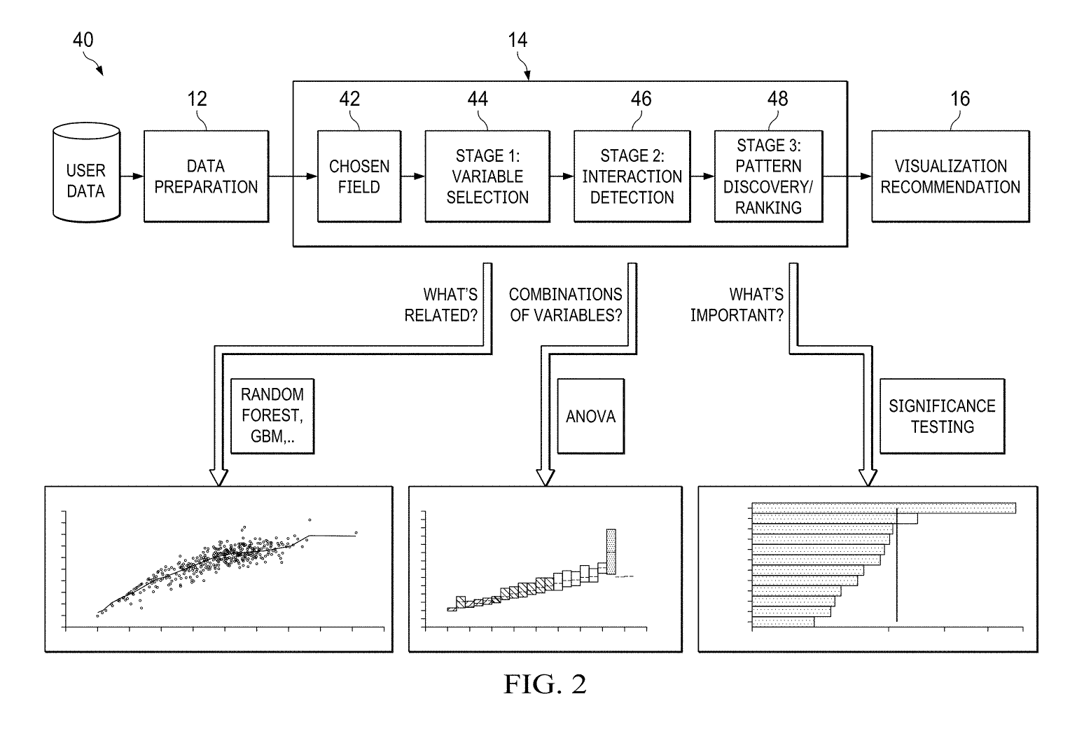

Referring now to FIG. 2, illustrated is a multiple stage, machine learning, predictive engine algorithm, in accordance to certain example embodiments, denoted generally as 40. Algorithm 40 can be employed in multiple stages to generate insights for curation and visualization worthy of user consumption. The algorithm 40 includes the data preparation 12, discovery 14, and heuristic visualization recommendation 16 functions. Discovery 14 includes chosen field element 42, stage 1—variable selection element 44, stage 2—interaction detections element 46, and stage 3—pattern discovery/ranking element.

In these stages, machine learning tools such as Random Forest, GBM (Gradient Boosting Machine), ANOVA (Analysis of Variance), and statistical significance testing can be used. The output of these stages can be used to influence visualization recommendation 16. Using one particular algorithm vs. another can be parameterized allowing customization. For example, some methods can work better than others with specific datasets. A different technique to use for this stage can be selected if those results are inappropriate for the business problem. Variables can be ranked according to the strength of their relationship with the target variable.

In general, the algorithm 40 samples user data and performs data preparation 12 that allows the subsequent analysis stages to operate in an efficient and more effective manner. Preparation techniques can include one or more of:
Variable Type Discovery—Determining Categorical/Continuous types, while accounting for issues such as categorical variables encoded as integer value;
Missing Data Processing—Imputation for continuous variables, such as adding a missing category for categorical data; and
Variable Transformations—Automatic variable transformations to normalize, bin, or other calculations based on statistical metadata, i.e. determine min/max, moments, percent, frequency counts, etc.

The user can then select a particular target variable of interest, i.e. chosen field 42. In some embodiments, this can be the only input that the algorithm 40 requires from a user. Choosing the variable after data preparation allows the algorithm 40 to remove or flag any variables that would never result in any useful insight (for example: variables with a constant value, or variables with too many missing values).

In various embodiments, algorithm 40 includes machine learning functions that are used to prepare the data to determine which variables best explain the variability in the user-chosen variable, stage 1—variable selection 44. Stage 1 finds variables that are independently associated with a user-chosen target variable. These are useful for bivariate (2-variable) charts between each of the independently associated variables against the chosen variable. As illustrated in FIG. 2, a variable selection function can be used to determine this association. At stage 2—interaction detection 46, combinations of these variables are discovered. Taken together, they can explain more of the variation in the user-chosen variable than taken separately. These variable sets can be used for multivariate visualizations. For example, all pairs of variables discovered in Stage 1 can be examined. Also, as illustrated in FIG. 2, a predictive modeling or statistical technique, such as ANOVA, can be used at stage 2. At stage 3—pattern discovery/ranking 48, a statistical significance test can be performed to determine whether an interaction effect is significant. If the interaction effect is found to be significant, the set of three variables is retained for use within a multivariate visualization. At stage 3, the algorithm 40 finds significant important relationships between variables. The techniques used can include variable importance techniques, statistical hypothesis testing, and simple Pearson correlation. Similarly, any best practice statistical procedure can be used to determine the significance of the interaction effect between two (or more) variables.

The result of the multi-stage process is a list of variable sets and result metrics that can be used by the visualization recommendation system 16 to define appropriate visualizations. The result metrics can be used to influence a heuristic visualization recommendation engine to better represent the relationship between the variables. For example, a heuristic visualization recommendation's rules can result in an arbitrary decision to apply one variable to the x-axis vs. another as a color variable with a legend. The machine learning metrics can indicate a stronger relationship to the y-axis variable for one of these variables allowing the recommendation system to choose a chart configuration that better depicts the business insight.

Additionally, the heuristic visualization recommendation 16 can use the metrics to detect outliers, i.e. unusual values, and denote findings that can be adorned in the final visualization. For example, given a categorical and continuous variable set, a routine can determine that the average value of the continuous variable for a given category of the categorical variable is unusually large relative to the other categories. The heuristic visualization recommendation 16 can use this information to choose to highlight this category in a bar chart, or highlight the point in a dot plot. Another example is using feature extraction (e.g. year and month) from metadata on date/time ranges, to find the best aggregation for constructing a heatmap visualization for a single date/time variable. Another example is using metadata on the number of distinct levels and the existence or not of outliers to triage between a box plot, a barchart or a heatmap visualization as the most appropriate visualization for continuous and categorical variable pairs. There are a number of methods for outlier detection depending on the nature of the variables. These are combined for improved detection. For instance, for continuous and continuous variable pairs, a cascade of grid-based and regression-based methods can be used. For categorical and categorical variable pairs, mutual frequency distribution and information content can be used to highlight rare levels.

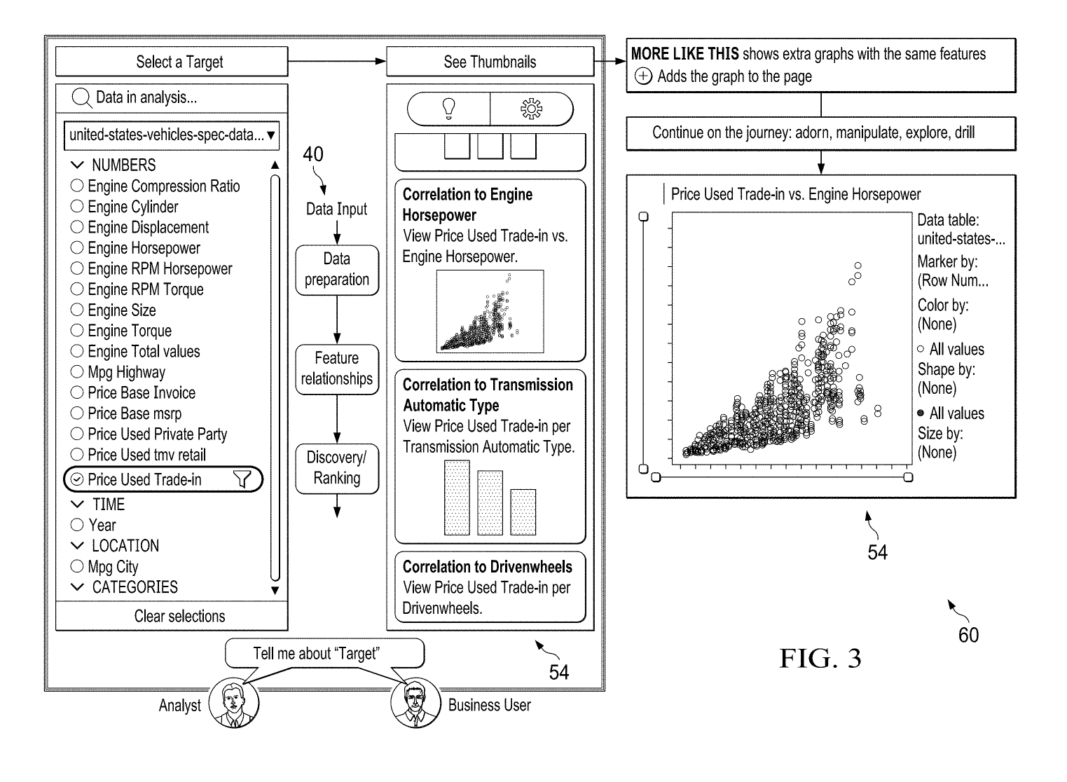

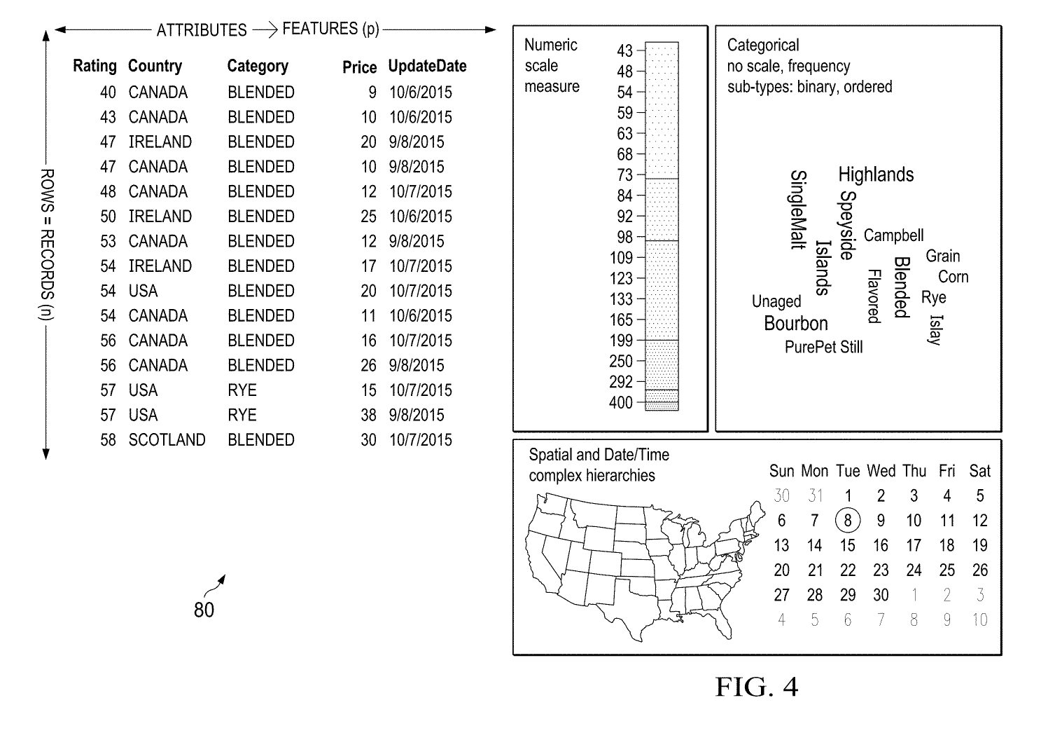

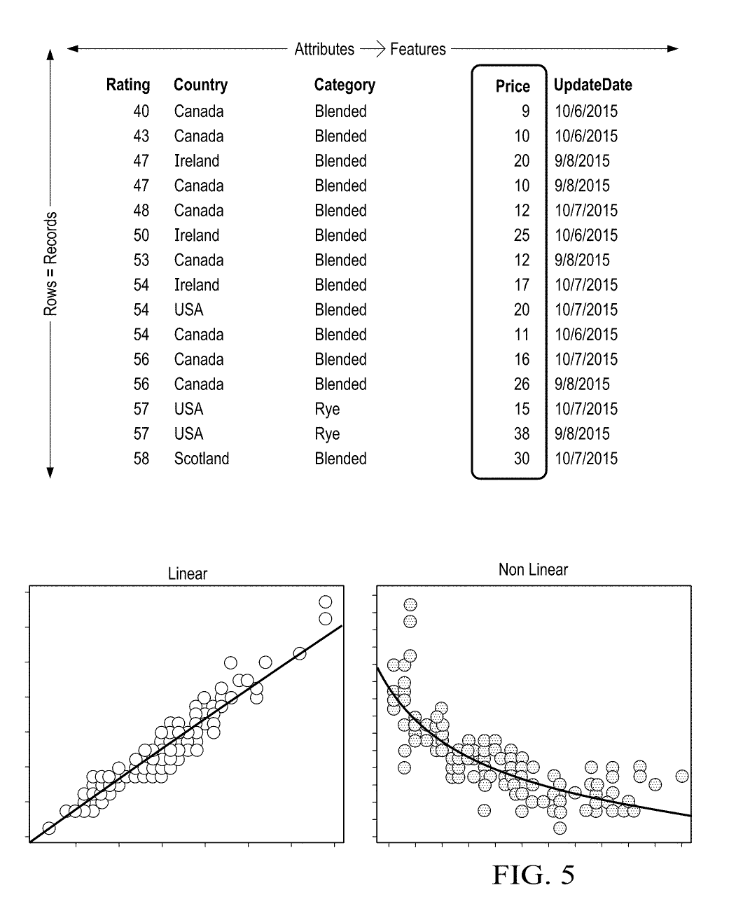

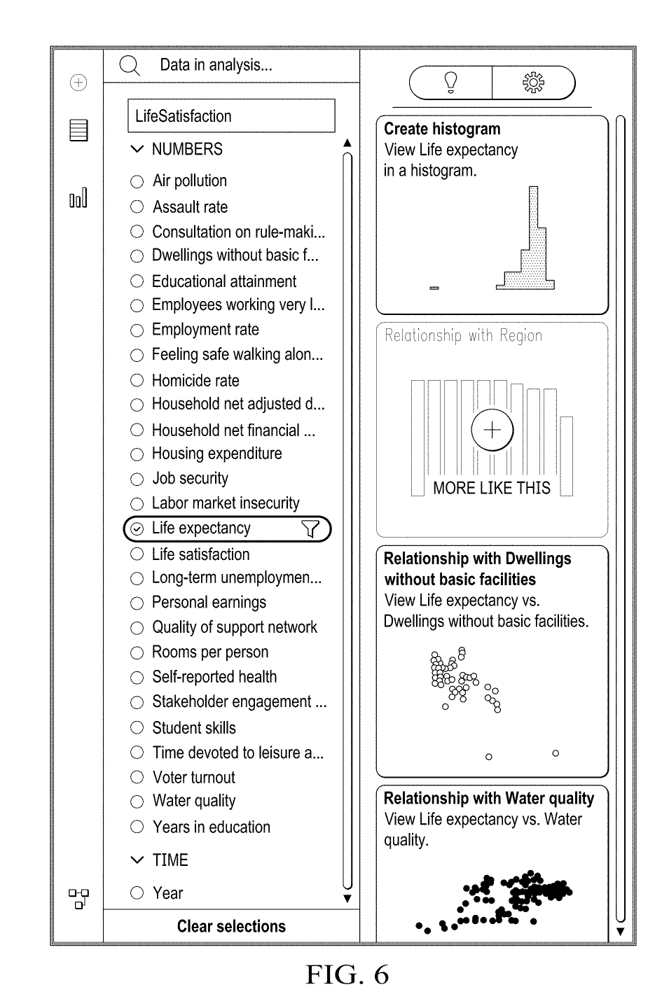

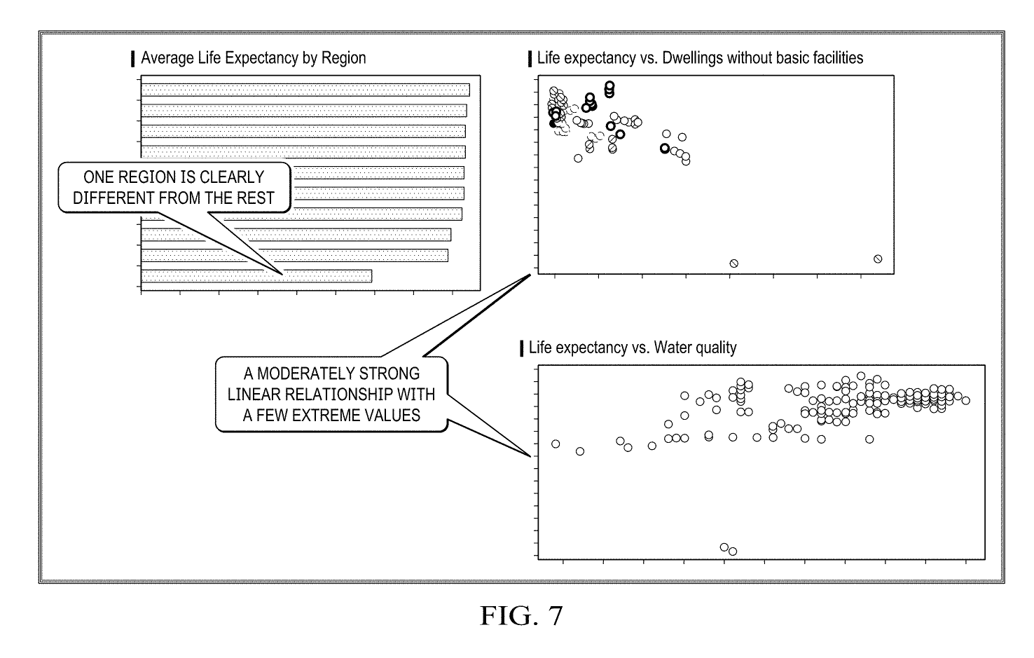

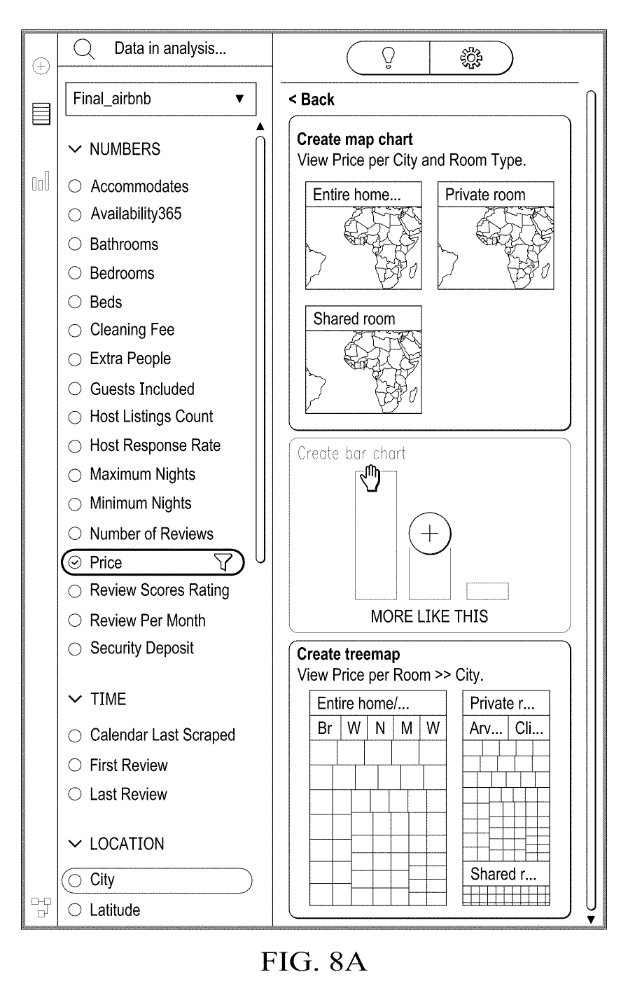

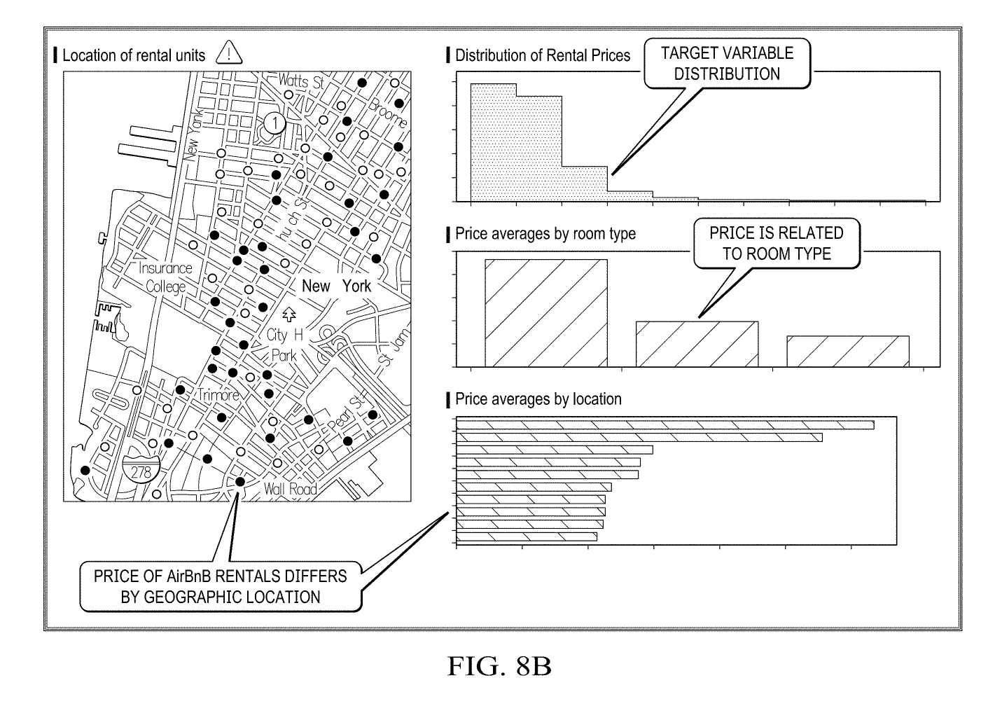

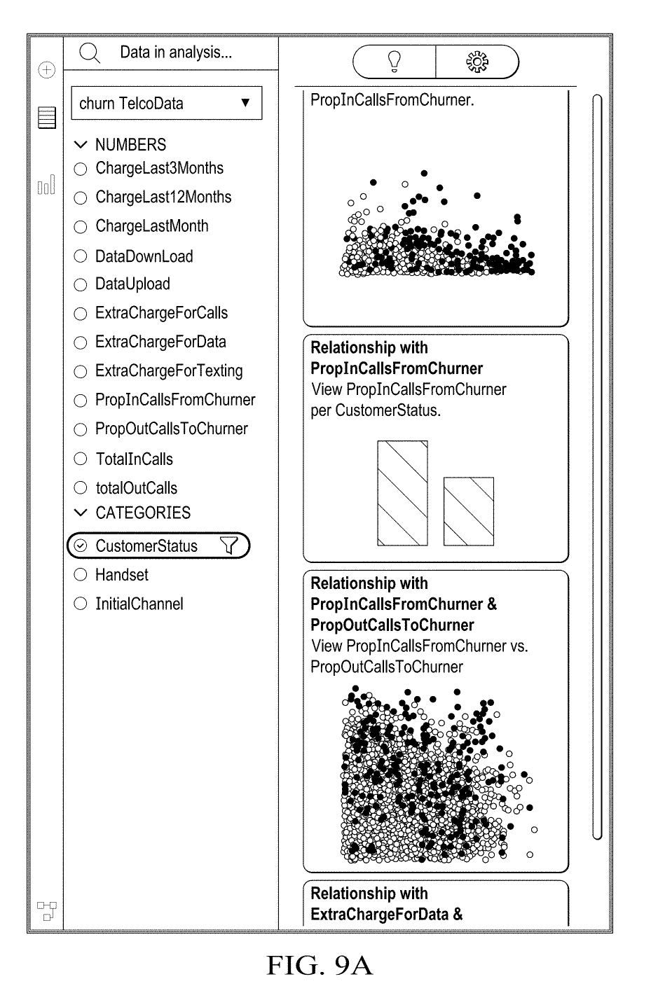

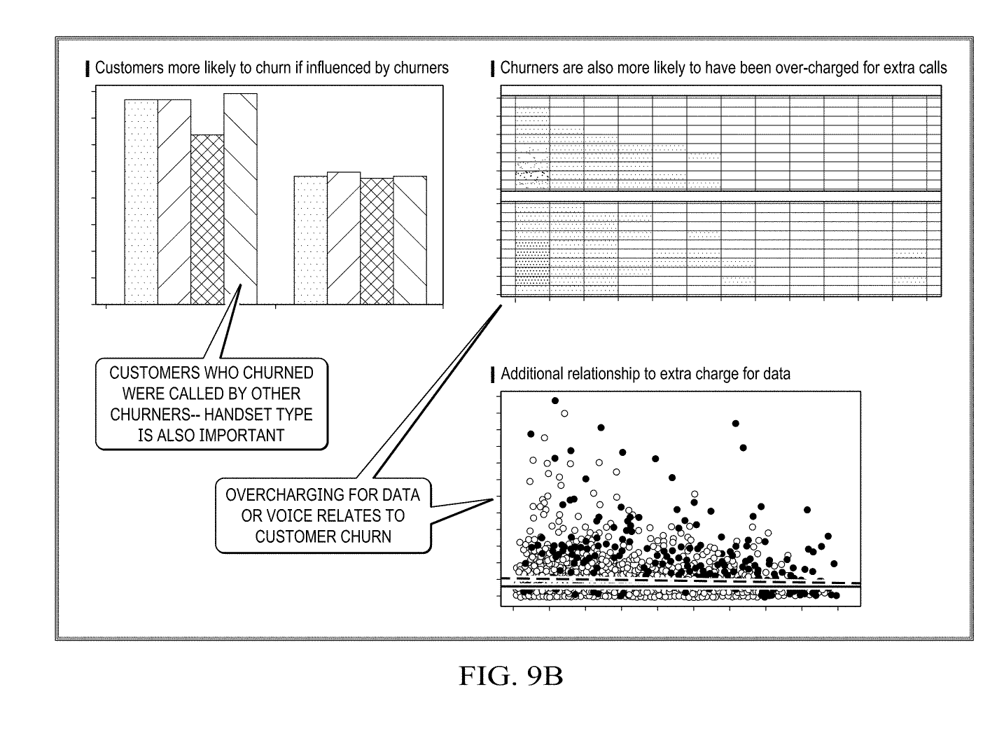

Referring now to FIGS. 3-9, illustrated are visualizations generated by predictive engine 40, in accordance with certain example embodiments. The illustrations demonstrate how a table of records can be processed and interpreted using a target variable, that is to say a feature attribute of the table, to determine linear, non-linear relationships, and any non-random patterns between targeted attribute variables and other attribute variables within the table.

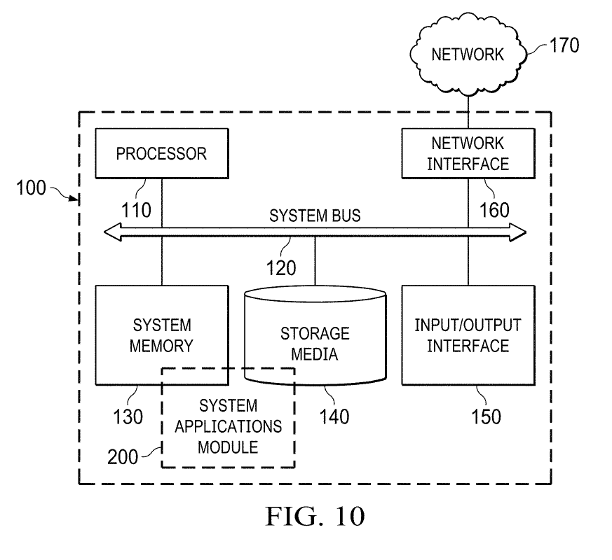

Referring now to FIG. 10, illustrated is a computing machine 100 and a system applications module 200, in accordance with example embodiments. The computing machine 100 can correspond to any of the various computers, mobile devices, laptop computers, servers, embedded systems, or computing systems presented herein. The module 200 can comprise one or more hardware or software elements, e.g. other OS application and user and kernel space applications, designed to facilitate the computing machine 100 in performing the various methods and processing functions presented herein. The computing machine 100 can include various internal or attached components such as a processor 110, system bus 120, system memory 130, storage media 140, input/output interface 150, and a network interface 160 for communicating with a network 170, e.g. cellular/GPS, Bluetooth, or WIFI.

The computing machines can be implemented as a conventional computer system, an embedded controller, a laptop, a server, a mobile device, a smartphone, a wearable computer, a customized machine, any other hardware platform, or any combination or multiplicity thereof. The computing machines can be a distributed system configured to function using multiple computing machines interconnected via a data network or bus system.

The processor 110 can be designed to execute code instructions in order to perform the operations and functionality described herein, manage request flow and address mappings, and to perform calculations and generate commands. The processor 110 can be configured to monitor and control the operation of the components in the computing machines. The processor 110 can be a general purpose processor, a processor core, a multiprocessor, a reconfigurable processor, a microcontroller, a digital signal processor (“DSP”), an application specific integrated circuit (“ASIC”), a controller, a state machine, gated logic, discrete hardware components, any other processing unit, or any combination or multiplicity thereof. The processor 110 can be a single processing unit, multiple processing units, a single processing core, multiple processing cores, special purpose processing cores, co-processors, or any combination thereof. According to certain embodiments, the processor 110 along with other components of the computing machine 100 can be a software based or hardware based virtualized computing machine executing within one or more other computing machines.

The system memory 130 can include non-volatile memories such as read-only memory (“ROM”), programmable read-only memory (“PROM”), erasable programmable read-only memory (“EPROM”), flash memory, or any other device capable of storing program instructions or data with or without applied power. The system memory 130 can also include volatile memories such as random access memory (“RAM”), static random access memory (“SRAM”), dynamic random access memory (“DRAM”), and synchronous dynamic random access memory (“SDRAM”). Other types of RAM also can be used to implement the system memory 130. The system memory 130 can be implemented using a single memory module or multiple memory modules. While the system memory 130 is depicted as being part of the computing machine, one skilled in the art will recognize that the system memory 130 can be separate from the computing machine 100 without departing from the scope of the subject technology. It should also be appreciated that the system memory 130 can include, or operate in conjunction with, a non-volatile storage device such as the storage media 140.

The storage media 140 can include a hard disk, a floppy disk, a compact disc read-only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 140 can store one or more operating systems, application programs and program modules, data, or any other information. The storage media 140 can be part of, or connected to, the computing machine. The storage media 140 can also be part of one or more other computing machines that are in communication with the computing machine such as servers, database servers, cloud storage, network attached storage, and so forth.

The applications module 200 and other OS application modules can comprise one or more hardware or software elements configured to facilitate the computing machine with performing the various methods and processing functions presented herein. The applications module 200 and other OS application modules can include one or more algorithms or sequences of instructions stored as software or firmware in association with the system memory 130, the storage media 140 or both. The storage media 140 can therefore represent examples of machine or computer readable media on which instructions or code can be stored for execution by the processor 110. Machine or computer readable media can generally refer to any medium or media used to provide instructions to the processor 110. Such machine or computer readable media associated with the applications module 200 and other OS application modules can comprise a computer software product. It should be appreciated that a computer software product comprising the applications module 200 and other OS application modules can also be associated with one or more processes or methods for delivering the applications module 200 and other OS application modules to the computing machine via a network, any signal-bearing medium, or any other communication or delivery technology. The applications module 200 and other OS application modules can also comprise hardware circuits or information for configuring hardware circuits such as microcode or configuration information for an FPGA or other PLD. In one exemplary embodiment, applications module 200 and other OS application modules can include algorithms capable of performing the functional operations described by the flow charts and computer systems presented herein.

The input/output (“I/O”) interface 150 can be configured to couple to one or more external devices, to receive data from the one or more external devices, and to send data to the one or more external devices. Such external devices along with the various internal devices can also be known as peripheral devices. The I/O interface 150 can include both electrical and physical connections for coupling the various peripheral devices to the computing machine or the processor 110. The I/O interface 150 can be configured to communicate data, addresses, and control signals between the peripheral devices, the computing machine, or the processor 110. The I/O interface 150 can be configured to implement any standard interface, such as small computer system interface (“SCSI”), serial-attached SCSI (“SAS”), fiber channel, peripheral component interconnect (“PCP”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 150 can be configured to implement only one interface or bus technology. Alternatively, the I/O interface 150 can be configured to implement multiple interfaces or bus technologies. The I/O interface 150 can be configured as part of, all of, or to operate in conjunction with, the system bus 120. The I/O interface 150 can include one or more buffers for buffering transmissions between one or more external devices, internal devices, the computing machine, or the processor 120.

The I/O interface 120 can couple the computing machine to various input devices including mice, touch-screens, scanners, electronic digitizers, sensors, receivers, touchpads, trackballs, cameras, microphones, keyboards, any other pointing devices, or any combinations thereof. The I/O interface 120 can couple the computing machine to various output devices including video displays, speakers, printers, projectors, tactile feedback devices, automation control, robotic components, actuators, motors, fans, solenoids, valves, pumps, transmitters, signal emitters, lights, and so forth.

The computing machine 100 can operate in a networked environment using logical connections through the NIC 160 to one or more other systems or computing machines across a network. The network can include wide area networks (WAN), local area networks (LAN), intranets, the Internet, wireless access networks, wired networks, mobile networks, telephone networks, optical networks, or combinations thereof. The network can be packet switched, circuit switched, of any topology, and can use any communication protocol. Communication links within the network can involve various digital or an analog communication media such as fiber optic cables, free-space optics, waveguides, electrical conductors, wireless links, antennas, radio-frequency communications, and so forth.

The processor 110 can be connected to the other elements of the computing machine or the various peripherals discussed herein through the system bus 120. It should be appreciated that the system bus 120 can be within the processor 110, outside the processor 110, or both. According to some embodiments, any of the processors 110, the other elements of the computing machine, or the various peripherals discussed herein can be integrated into a single device such as a system on chip (“SOC”), system on package (“SOP”), or ASIC device.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions unless otherwise disclosed for an exemplary embodiment. Further, a skilled programmer would be able to write such a computer program to implement an embodiment of the disclosed embodiments based on the appended flow charts, algorithms and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the description herein.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

The foregoing description of embodiments of the disclosure has been presented for purposes of illustration and description. It is not intended to be exhaustive or to limit the disclosure to the precise form disclosed, and modifications and variations are possible in light of the above teachings or may be acquired from practice of the disclosure. The embodiments were chosen and described in order to explain the principals of the disclosure and its practical application to enable one skilled in the art to utilize the disclosure in various embodiments and with various modifications as are suited to the particular use contemplated. Other substitutions, modifications, changes and omissions may be made in the design, operating conditions and arrangement of the embodiments without departing from the scope of the present disclosure. Such modifications and combinations of the illustrative embodiments as well as other embodiments will be apparent to persons skilled in the art upon reference to the description. It is, therefore, intended that the appended claims encompass any such modifications or embodiments.

What is claimed is:

1. A predictive engine for interpreting data structures, the predictive engine comprising:
an interpreter configured to identify a relational pattern between target feature variables and other feature variables based on recognizing a variable dependency between the target feature data and the other feature data and generate at least one meta-data feature set and associated result metrics;
a visualization generator configured to recommend at least one visualization based on the at least one meta-data feature set and the associated result metrics.

2. The predictive engine of claim 1 wherein the interpreter includes multiple stages for performing variable selection, interaction detection, and pattern discovery and ranking.

3. The predictive engine of claim 1 wherein the variable dependency is one of a linear, non-linear relationship, and non-random pattern.

4. The predictive engine of claim 1 further comprising a data preparer configured to sort, categorize, and filter the data structures according to at least one of data type, hierarchical data structures, unique values, missing values and date/time data.

5. The predictive engine of claim 1 wherein the interpreter is further configured to perform a statistical test to determine whether an interaction effect is significant.

6. The predictive engine of claim 1 wherein the visualization generator generates at least one or more of a multivariate chart and bivariate chart.

7. The predictive engine of claim 1 wherein the visualization generator is further configured to apply heuristic based rules to recommend the at least one visualization.

8. A method for operating a predictive engine to interpret data structures, the method comprising:
identifying a relational pattern between target feature data and other feature data based on recognizing a variable dependency between the target feature data and the other feature data;
generating at least one meta-data feature set and associated result metrics; and
recommending at least one visualization based on the at least one meta-data feature set and the associated result metrics.

9. The method of claim 8 wherein the step of identifying and generating is performed at a first, second, and third stage or more stages wherein variable selection, interaction detection, and pattern discovery and ranking are performed.

10. The method of claim 8 wherein the variable dependency is one of a linear or non-linear relationship or any non-random pattern.

11. The method of claim 8 further comprising: sorting, categorizing, and filtering the data structures according to at least one of data type, hierarchical data structures, unique values, missing values and date/time data.

12. The method of claim 8 further comprising performing a statistical test to determine whether an interaction effect is significant.

13. The method of claim 1 further comprises generating at least one multivariate chart and bivariate chart.

14. A non-transitory computer readable storage medium comprising a set of computer instructions executable by a processor for operating a predictive engine to interpret data structures, the computer instructions configured to:
identify a relational pattern between target feature data and other feature data based on recognizing a variable dependency between the target feature data and the other feature data;
generate at least one meta-data feature set and associated result metrics; and
recommend at least one visualization based on the at least one meta-data feature set and the associated result metrics.

15. The non-transitory computer readable storage medium as recited in claim 14 further including computer instructions configured to identify and generate the relational pattern and at least one meta-data feature set and associated result metrics at a first, second, and third stage or more stages wherein variable selection, interaction detection, and pattern discovery and ranking are performed.

16. The non-transitory computer readable storage medium as recited in claim 14 wherein the variable dependency is one of a linear and non-linear relationship.

17. The non-transitory computer readable storage medium as recited in claim 14 further including computer instructions configured to sort, categorize, and filter the data structures according to at least one of data type, hierarchical data structures, unique values, missing values and date/time data.

18. The non-transitory computer readable storage medium as recited in claim 14 further including computer instructions configured to perform a statistical test to determine whether an interaction effect is significant.

19. The non-transitory computer readable storage medium as recited in claim 14 further including computer instructions configured to generate at least one of a multivariate chart and a bivariate chart.

20. The non-transitory computer readable storage medium as recited in claim 14 further including computer instructions configured to apply heuristic based rules to recommend the at least one visualization.
